(19) United States
(12) Patent Application Publication
(10) Pub. No.: US 2014/0118302 A1
(43) Pub. Date: May 1, 2014

(54) TOUCH SENSING APPARATUS AND MANUFACTURING THEREOF

(71) Applicant: Samsung Electronics Co., Ltd., Suwon-si (KR)

(72) Inventors: Joongdae PARK, Cheongwon-gun (KR); Hoon-Do HEO, Suwon-si (KR)

(73) Assignee: Samsung Electronics Co., Ltd., Suwon-si (KR)

(21) Appl. No.: 14/068,489

(22) Filed: Oct. 31, 2013

(30) Foreign Application Priority Data
Oct. 31, 2012 (KR) 10-2012-0122382

(51) Int. Cl. G06F 3/044

(52) U.S. Cl. CPC G06F 3/044
USPC 345/174; 29/622

(57) ABSTRACT

A touch sensing apparatus is provided. The apparatus includes a window having an uneven thickness, and a capacitive touch panel disposed under the window and having alternating electrode lines comprising a plurality of electrodes in parallel. At least one of an electrode size and an electrode gap of the electrode lines is formed according to the thickness of the window.

### CROSS-REFERENCE TO RELATED APPLICATION(S)

The present application claims the benefit under 35 U.S.C. §119(a) of a Korean patent application filed on Oct. 31, 2012 in the Korean Intellectual Property Office and assigned Serial No. 10-2012-0122382, the entire disclosure of which is hereby incorporated by reference.

### TECHNICAL FIELD

The present disclosure relates to a touch sensing apparatus and a manufacturing method thereof. More particularly, the present disclosure relates to a touch sensing apparatus having a uniform touch sensitivity per touch region in a capacitive touch screen including a window of an irregular thickness, and a manufacturing method thereof.

### BACKGROUND

In recent, based on abrupt supply increase of portable electronic devices, the portable electronic device becomes a necessity in modern life. As the portable electronic device provides not only a voice telephony service but also various data transfer services and various additional services, the portable electronic device is changing into a multimedia communication device. With the growth of the services of the portable phone, a User Interface (UI) technique for controlling the portable electronic device is continuously being developed.

Notably, as recent portable electronic devices highly uses a touch screen based on a Graphical User Interface (GUI), the touch screen has widely been adopted for use in portable electronic devices according to the related art.

FIG. 1 is a diagram of a touch sensing device according to the related art and a graph illustrating a touch sensitivity measured per touch region.

Referring to FIG. 1, the touch sensing device includes a window 101, a capacitive touch panel 110, and a touch controller 130.

The window 101 is disposed above the capacitive touch panel 110 to protect the capacitive touch panel 110 from the external environment. For the touch input, a user touches a surface of the window 101. The window 101 is formed to have an irregular thickness. For example, the window 101 may be formed to have a concave surface profile. The curvature (e.g., the concave surface) may face the external environment. The window 101 may be formed so as to be curved along the x axis 1011 and may be formed so as to be flat along the y axis 1012.

The capacitive touch panel 110 alternates x electrode lines 111 and y electrode lines 112 in parallel. The x electrode lines 111 are arranged vertically at regular intervals, and the y electrode lines 112 are insulated from the x electrode lines 111 and arranged horizontally at regular intervals. The x electrode lines 111 and the y electrode lines 112 include a plurality of electrodes.

The touch controller 130 applies voltage to the x electrode lines 111 and the y electrode lines 112 of the capacitive touch panel 110, and the capacitive touch panel 110 creates an electric field. The touch controller 130 detects touch based on the change of the electric field (or capacitance) of the capacitive touch panel 110.

Because the electrodes of the capacitive touch panel 110 have the same size and the uniform gap between them, the capacitive touch panel 110 creates the uniform electric field throughout the surface thereof. However, the thickness of the window 101 is not uniform and a distance from the finger to the capacitive touch panel 110 varies according to the thickness of the window 101. As a result, the uniform magnetic field change is not induced throughout the whole touch region. This uneven touch sensitivity all over the touch region causes dissatisfaction to the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a touch sensing apparatus having a uniform touch sensitivity per touch region in a capacitive touch screen including a window of an irregular thickness.

In accordance with an aspect of the present disclosure, a touch sensing apparatus is provided. The apparatus includes a window having an uneven thickness, and a capacitive touch panel disposed under the window and having alternating electrode lines comprising a plurality of electrodes in parallel. At least one of an electrode size and an electrode gap of the electrode lines being formed according to the thickness of the window.

In accordance with another aspect of the present disclosure, a touch screen is provided. The touch screen includes a window having an uneven thickness, a capacitive touch panel disposed under the window and having alternating electrode lines comprising a plurality of electrodes in parallel, a display disposed under the capacitive touch panel and configured to output an image provided from a host device, and a touch controller configured to apply a voltage to the capacitive touch panel, to detect a touch based on a change of an electric field of the panel, and to notify the host device of a detected touch. At least one of an electrode size and an electrode gap of the electrode lines of the capacitive touch panel being formed according to the thickness of the window.

In accordance with another aspect of the present disclosure, a method for manufacturing a touch sensing apparatus is provided. The method includes fabricating a window having an uneven thickness, and fabricating a capacitive touch panel by adjusting at least one of an electrode size and an electrode gap of electrode lines according to the thickness of the window.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram of a touch sensing device according to the related art and a graph illustrating a touch sensitivity measured per touch region;

FIG. 2 is a perspective view of a portable terminal according to an embodiment of the present disclosure;

FIG. 3 is a diagram of a touch screen according to an embodiment of the present disclosure;

FIG. 4 is a block diagram of a portable terminal according to an embodiment of the present disclosure;

FIG. 5 is a diagram of a touch sensing apparatus and a graph illustrating a touch sensitivity per touch region according to an embodiment of the present disclosure;

FIGS. 6 and 7 are diagrams of a touch sensing apparatus according to an embodiments of the present disclosure;

FIG. 8 is a diagram of an electric field created according to a gap between electrodes in a capacitive touch panel according to an embodiment of the present disclosure; and

FIG. 9 is a flowchart of a method for manufacturing a touch sensing apparatus according to an embodiment of the present disclosure.

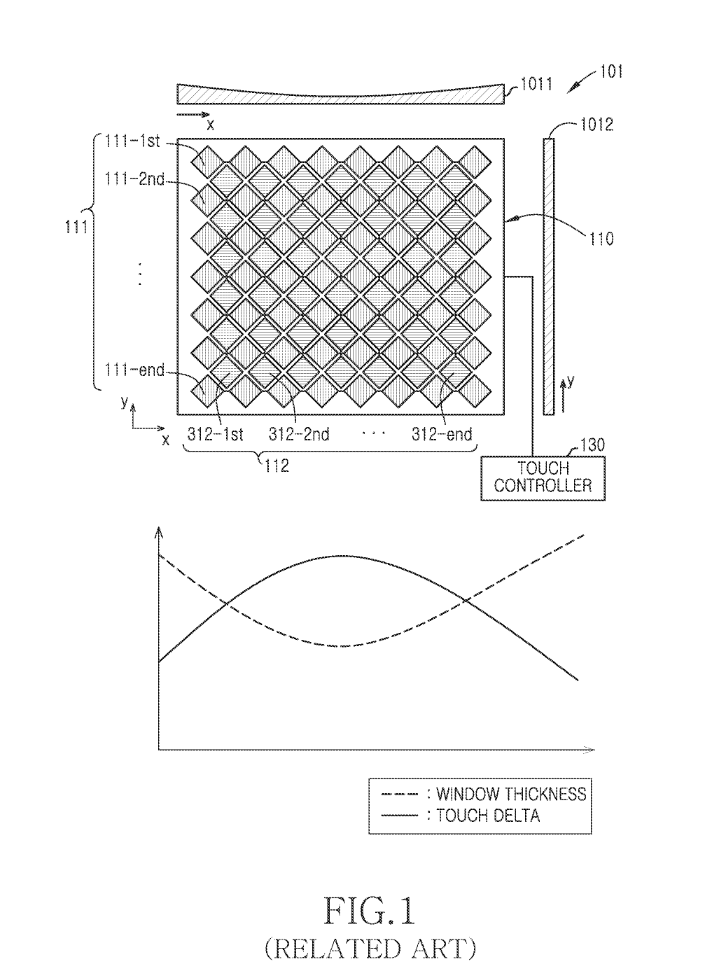

Throughout the drawings, like reference numerals will be understood to refer to like parts, components and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

According to various embodiments of the present disclosure, an electronic device may be a device having a communication function. For example, the electronic device can include at least one of a smart phone, a tablet Personal Computer (PC), a mobile phone, a videophone, an e-book reader, a desktop PC, a Personal Digital Assistant (PDA), a Portable Multimedia Player (PMP), an MP3 player, a mobile medical device, a camera, a Global Positioning System (GPS) navigation, a wearable device (e.g., Head-Mounted-Device (HMD) such as electronic glasses, electronic apparel, electronic bracelet, electronic necklace, electronic accessory, or smart watch), and/or the like.

According to various embodiments of the present disclosure, the electronic device may include a smart home appliance having the communication function. The smart home appliance can include at least one of, for example, a television (TV), a Digital Video Disk (DVD) player, an audio system, a refrigerator, an air conditioner, a vacuum cleaner, an oven, a microwave oven, a washer, an air cleaner, a set-top box, a TV box (e.g., Samsung HomeSync™, AppleTV™, or GoogleTV™), a game console, an electronic dictionary, a camcorder, a digital frame, and/or the like.

According to various embodiments of the present disclosure, the electronic device can include at least one of various medical devices (e.g., Magnetic Resonance Angiography (MRA), Magnetic Resonance Imaging (MRI), Computed Tomography (CT), X-ray machine, and scanner), a navigation device, a Global Positioning System (GPS) receiver, an Event Data Recorder (EDR), a Flight Data Recorder (FDR), a vehicle infotainment device, marine electronic equipment (e.g., marine navigation system and gyrocompass), avionics, a security device, and the like.

According to various embodiments of the present disclosure, the electronic device can include at least one of part of furniture or a building/structure having the communication function, an electronic board, an electronic signature receiving device, a projector, and a gauge (e.g., water, electricity, gas, or radio signal). The electronic device can include one or a combination of the various devices. Notably, one skilled in the art shall understand that the electronic device is not limited to those devices.

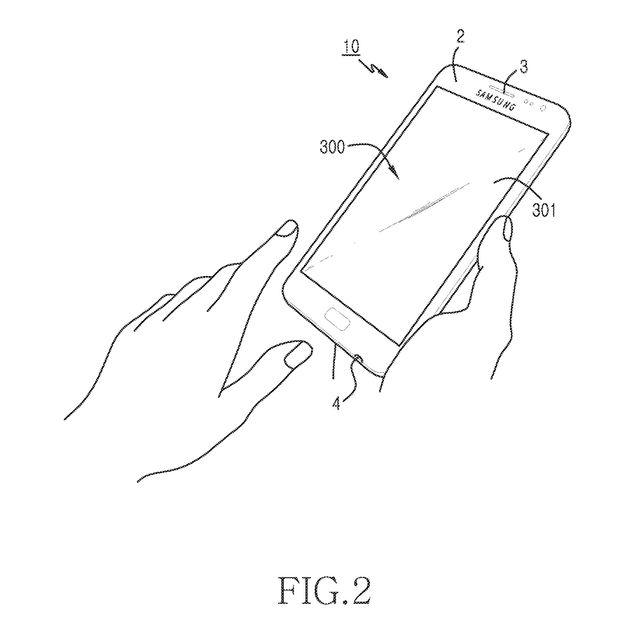

FIG. 2 is a perspective view of a portable terminal according to an embodiment of the present disclosure.

Referring to FIG. 2, a portable terminal may include a speaker 3, a microphone 4, and a touch screen 300.

The touch screen 300 is mounted on a front side 2 of the portable terminal 10. The touch screen 300 can support data input/output and concurrently detect the touch.

The speaker 3 for converting and outputting an electric signal in an audible frequency band and a microphone 4 for converting sound waves from a person or a sound source to the electric signal can be mounted to an upper part of the touch screen 300. According to various embodiments of the present disclosure, the speaker may be mounted to an upper part of the touch screen 300 or an upper part of the front side 2, and the microphone 4 may be mounted to a lower part of the touch screen 300 or a lower part of the front side 2.

The touch screen 300 includes a window 301 for covering a capacitive touch panel. The window 301, which is formed of a transparent material, can be attached to the touch panel or secured to a housing of the exterior.

In particular, the window 301 has an uneven thickness. A bottom side facing the touch panel is flat but the top side exposed to the external environment can be curved. For example, the window 301 can be formed to be relatively thicker at the periphery or at the center. Such a window 301 may be exposed the exterior of the portable terminal 10.

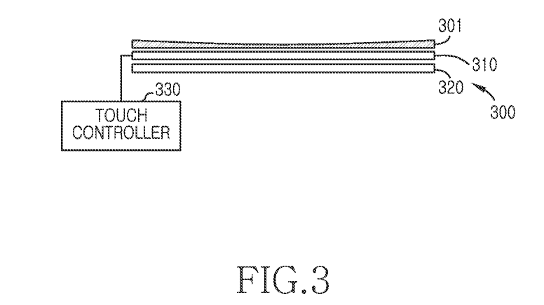

FIG. 3 is a diagram of a touch screen according to an embodiment of the present disclosure.

Referring to FIG. 3, the touch screen 300 can include a display 320, a capacitive touch panel 310 disposed on the display 320, and a touch controller 330 electrically connected with the window 301 on the touch panel 310 and the capacitive touch panel 310.

The window 301 is a transparent plate contacted by the user and protects the capacitive touch panel 310 from the external environment. Particularly, the window 301 has the uneven thickness and is exposed to the exterior of the portable terminal 10. The display 320 is seen from the external environment through the window 301. The curvature of the window 301 may be exposed to the external environment.

The display 320 can output visual information. For example, the display 320 may output text, graphics, video, and the like. The visual information may be provided to the display 320 from a host device (not shown), or the like.

The capacitive touch panel 310 can create the electric field for the touch according to the voltage applied from the touch controller 330. The touch is detected due to the change of the electric field. For example, when the finger approaches the electric field, the electric field can change. The capacitive touch panel 310 can alternate electrode lines including a plurality of electrodes in parallel. The electrode lines of the capacitive touch panel 310 can be fabricated by adjusting at least one of an electrode size and a gap between the electrodes according to the thickness of the window 301.

The capacitive touch panel 310 can be attached to the window 301 using an adhesive. The adhesive can include Super View Resin (SVR), Optically Clear Adhesive (OCA), and/or the like.

The touch controller 330 can detect the touch input based on the electric field change of the capacitive touch panel 310 and forward the detected touch input to the host device (not shown), or the like.

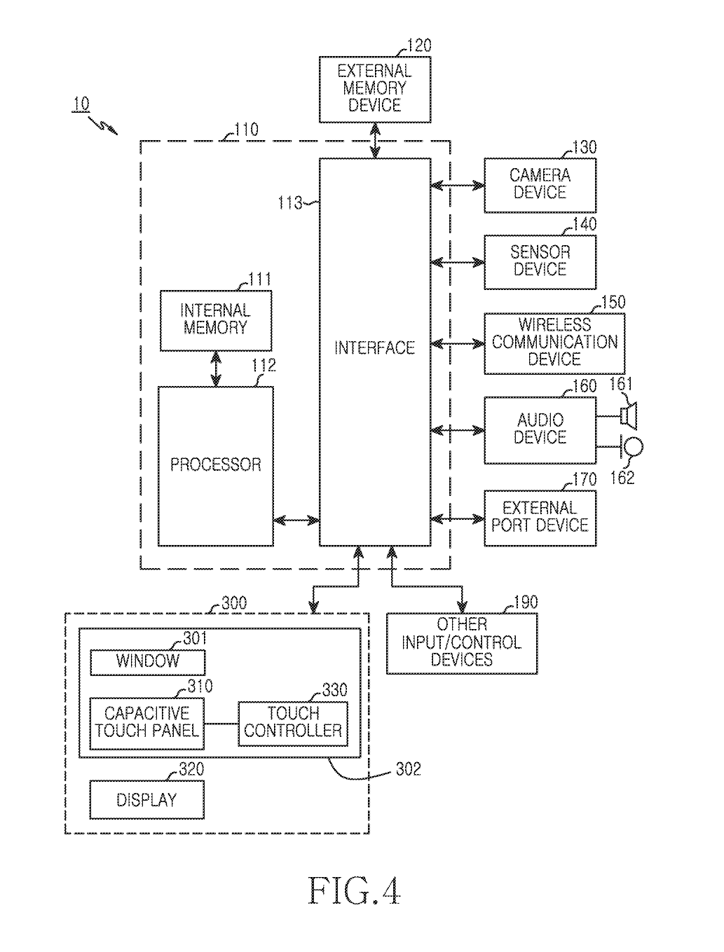

FIG. 4 is a block diagram of a portable terminal according to an embodiment of the present disclosure.

Referring to FIG. 4, the portable terminal 10 can include a host device 110, an external memory device 120, a camera device 130, a sensor device 140, a wireless communication device 150, an audio device 160, an external port device 170, a touch screen 300, and other input/control devices 190. According to various embodiments of the present disclosure, the portable terminal 10 may include a plurality of memory devices 120 and/or a plurality of external port devices 170.

The host device 110 includes an internal memory 111, one or more processors 112, and an interface 113. The internal memory 111, the one or more processors 112, and the interface 113 can be embodied separately or integrated onto at least one integrated circuit.

The one or more processors 112 performs various functions for the portable terminal 10 by executing various software programs, and processes and controls voice communication, video communication, data communication, and the like. In addition to those typical functions, the at least one processor 112 executes a software module (an instruction set) stored in the internal memory 111 and/or the external memory device 120 and performs various functions corresponding to the module. The at least one processor 112 can also execute a particular software module (instruction set) stored in the internal memory 111 and/or the external memory device 120 and perform particular functions corresponding to the module. The at least one processor 112 performs the method according to various embodiments of the present disclosure in association with the software modules stored in the internal memory 111 and/or the external memory device 120. The at least one processor 112 can include one or more data processors, an image processor, or a CODEC. Further, the portable terminal 10 may separately include the data processor, the image processor, or the CODEC.

The interface 113 interconnects various devices of the portable terminal 10 with the host device 110.

The camera device 130 can perform camera functions such as photo and video clip recording. The camera device 130 can include a Charged Coupled Device (CCD) or a Complementary Metal-Oxide Semiconductor (CMOS). According to the camera module executed by the at least one processor 112, the camera device 130 can modify a hardware structure, for example, move a lens or adjust an F number of an iris.

The various components of the portable terminal 10 can be coupled using one or more communication buses or stream lines.

The sensor device 140 includes a motion sensor, an optical sensor, a temperature sensor, and/or the like, and allows various functions. For example, the motion sensor can detect the motion of the portable terminal 10, and the optical sensor can detect the ambient light.

The wireless communication device 150 allows wireless communication and can include radio frequency transmitter and receiver, optical (e.g., infrared light) transmitter and receiver, and/or the like. Depending on a communication network, the wireless communication device 150 can be designed to operate over one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless Fidelity (Wi-Fi) network, a WiMax network, a Bluetooth network, and/or the like.

The audio device 160 is coupled to a speaker 161 and a microphone 162 to process audio input and output such as voice recognition, voice reproduction, digital recording, and telephone function. For example, the audio device 160 can communicate with the user through the speaker 161 and the microphone 162. The audio device 160 receives a data signal from the host device 110, converts the received data signal to an electric signal, and outputs the converted electric signal to the speaker 161. The speaker 161 converts the electric signal into the audible frequency band. The microphone 162 converts a sound wave from the person or other sound sources to an electric signal. The audio device 160 receives the electric signal from the microphone 162, converts the received electric signal to the audio data signal, and sends the converted audio data signal to the host device 110. The audio device 160 can include an ear phone, head phone, head set, and/or the like, attachable and detachable to and from the portable terminal 10.

The external port device 170 can connect the portable terminal 10 to other electronic device directly or indirectly via the network (e.g., Internet, intranet, wireless LAN, and/or the like).

The touch screen 300 can provide an I/O interface between the portable terminal 10 and the user. For example, the touch screen 300 applies a touch detection technology, forwards a user's touch input to the host device 110, and displays visual information provided from the host device 110. For example, the touch screen 300 may display text, graphic, video, and/or the like to the user.

The touch screen 300 can include the display 320 and a touch sensing apparatus 302.

The display 320 can output the visual information. For example, the display 320 may output text, graphics, video, and/or the like. As an example, the visual information may be provided to the display 320 from the host device 110.

The touch sensing apparatus 302 can include the window 301, the capacitive touch panel 310, and the touch controller 330.

The capacitive touch panel 310 can create the electric field for the touch according to the voltage applied from the touch controller 330.

The capacitive touch panel 310 can alternate the electrode lines including the plurality of electrodes in parallel. According to various embodiments of the present disclosure, the window 301 has an uneven thickness, and the electrode lines of the capacitive touch panel 310 can be fabricated by adjusting at least one of the electrode size or the gap between the electrodes according to the thickness of the window 301.

The touch controller 330 can detect the touch input based on the electric field change of the capacitive touch panel 310 and forward the touch input to the host device (not shown).

The other input/control devices 190 can include up/down buttons for volume control. Besides, the other input/control devices 190 can include at least one of a push button, a rocker button, a rocker switch, a thumb wheel, a dial, a stick, a pointer such as stylus, and/or the like which is given the corresponding function.

The external memory device 120 includes fast random access memory such as one or more magnetic disc storage devices and/or non-volatile memory, one or more optical storage devices, a flash memory (e.g., NAND and NOR), and/or the like. The external memory device 120 stores software, and the software includes an operating system module, a communication module, a graphic module, a user interface module, a CODEC module, a camera module, one or more application modules, and/or the like. The term ‘module’ can be referred to as a set of instructions, an instruction set, or a program.

The operating system module indicates an embedded operating system such as WINDOWS, LINUX, Darwin, RTXC, UNIX, OS X, or VxWorks, and includes various software components for controlling general system operations. The various software components for controlling general system operations include, for example, memory management and control, storage hardware (device) control and management, and power control and management. The operating system module processes normal communication between various hardware (devices) and software components (modules).

The communication module allows communication with other portable terminal such as computer, server, and electronic device, through the wireless communication device 150 or the external port device 170.

The graphic module includes various software components for providing and displaying graphics on the touch screen 180. The term ‘graphics’ encompasses text, web page, icon, digital image, video, animation, and the like.

The user interface module includes various software components relating to a user interface. The user interface module is involved in the status change of the user interface and the condition of the user interface status change.

The CODEC module can include software components relating to video file encoding and decoding.

The camera module includes camera related software components allowing camera related processes and functions.

The application module can include a browser, an e-mail, an instant message, a word processing, keyboard emulation, an address book, a touch list, a widget, Digital Right Management (DRM), voice recognition, voice reproduction, a position determining function, and a location based service. The memory 110 can further include additional modules (instructions) besides the above-stated modules.

The various functions of the portable terminal 10 as stated above and to be explained, can be executed by hardware and/or software and/or their combination including one or more stream processing and/or Application Specific Integrated Circuits (ASICs).

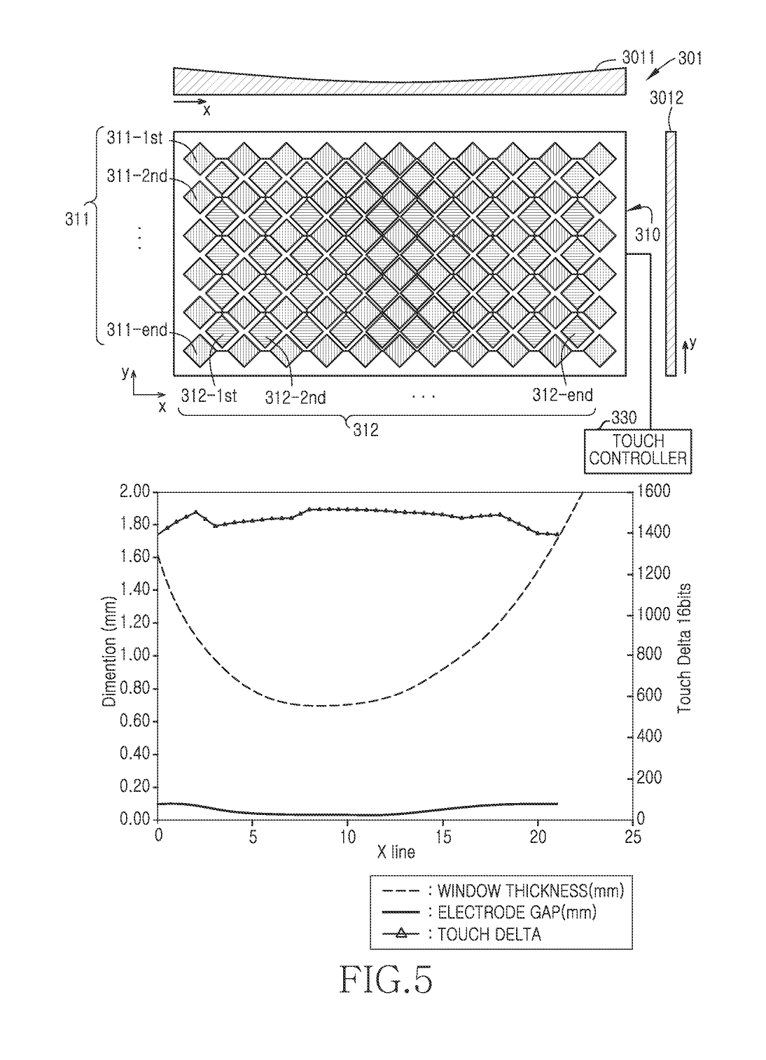

FIG. 5 is a diagram of the touch sensing apparatus and a graph illustrating the touch sensitivity per touch region according to an embodiment of the present disclosure.

Referring to FIG. 5, the touch sensing apparatus can include the window 301, the capacitive touch panel 310, and the touch controller 330.

The window 301 can be disposed on the capacity touch panel 310 and may have the uneven thickness. For example, the window 301 can be curved 3011 based on the x axis and flat 3012 based on the y axis. As an example, the window 301 may have a concave profile with the curved portion facing the external environment.

The capacity touch panel 310 can include x electrode lines 311 and y electrode lines 312 insulated from the x electrode lines 311. The x electrode lines 311 and the y electrode lines 312 can be alternated in parallel, and include the electrodes. The capacity touch panel 310 can be fabricated by forming the x electrode lines 311 and the y electrode lines 312 on the single glass.

More specifically, the gap between the electronics of the x electrode lines 311 and the y electrode lines 312 of the capacity touch panel 310 can be determined by the thickness of the window 301. For example, the gap between the electrodes of the capacity touch panel 310 corresponding to the relatively thick portion of the window 301 can be relatively wide as shown in FIG. 5.

The touch controller 330 can apply the voltage to the x electrode lines 311 and the y electrode lines 312 of the capacitive touch panel 310, and the capacitive touch panel 310 creates the electric field.

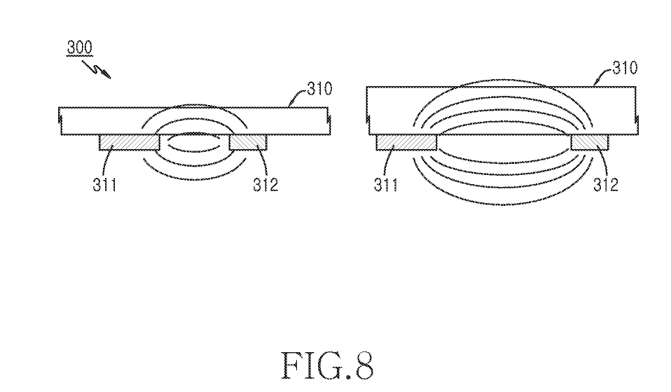

FIG. 8 is a diagram of an electric field created according to a gap between the electrodes in a capacitive touch panel according to an embodiment of the present disclosure.

Referring to FIG. 8, the gap between the x electrode 311 and the y electrode 312 corresponding to the relatively thick portion of the window 301 are relatively lengthened. At this time, the electric field is extended as much as the thickness of the window 301.

Although the thickness of the window 301 is not uniform in FIG. 5, the gap between the electrodes is adjusted and thus the touch sensitivity is even all over the touch region.

A dummy line may be disposed between the electrodes of the electrode lines 311 and 312, to obtain visibility.

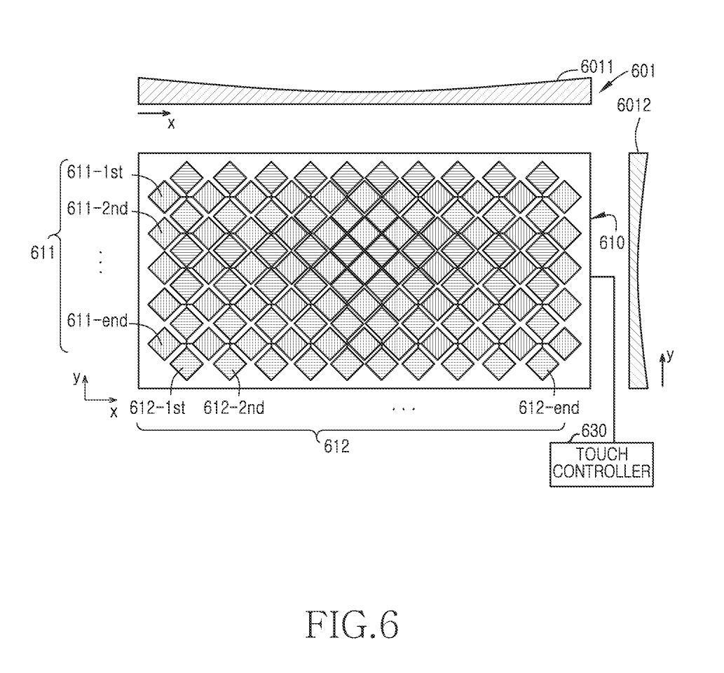

FIG. 6 is a diagram of a touch sensing apparatus according to an embodiment of the present disclosure.

Referring to FIG. 6, the touch sensing apparatus can include a window 601, a capacitive touch panel 610, and a touch controller 630.

The window 601 can be disposed on the capacity touch panel 610 and have the uneven thickness. In contrast to the touch sensing apparatus illustrated in FIG. 5, the window 601 can be curved based on the x axis 6011 and the y axis 6012.

The capacity touch panel 610 can include x electrode lines 611 and y electrode lines 612 insulated from the x electrode lines 611. The x electrode lines 611 and the y electrode lines 612 can be alternated in parallel, and include the electrodes.

According to various embodiments of the present disclosure, the gap between the electronics of the x electrode lines 611 and the y electrode lines 612 of the capacity touch panel 610 can be determined by the thickness of the window 601. For example, the gap between the electrodes of the capacity touch panel 610 corresponding to the relatively thick portion of the window 601 can be relatively wide. The capacity touch panel 610 can be fabricated such that the gap between the electrodes is smaller at the center as shown in FIG. 6.

The touch controller 630 can apply the voltage to the x electrode lines 611 and the y electrode lines 612 of the capacitive touch panel 610, and the capacitive touch panel 610 can create the electric field.

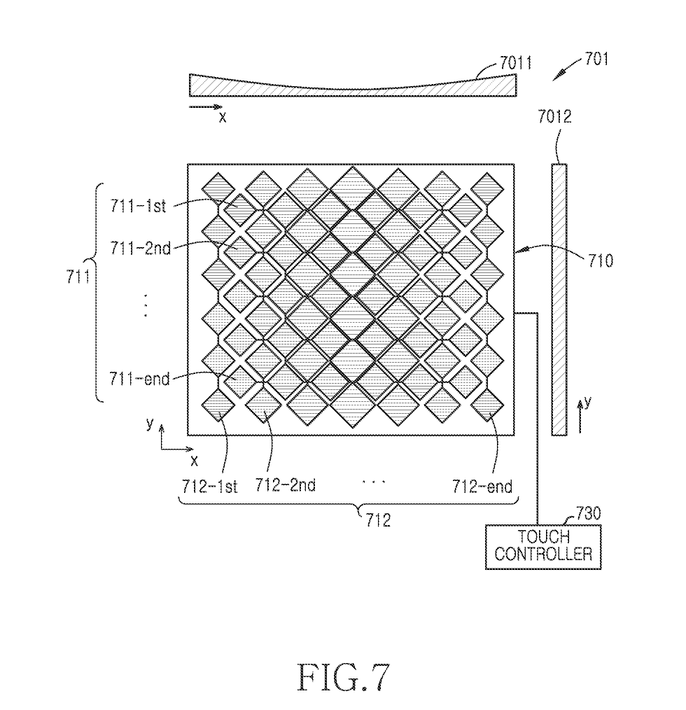

FIG. 7 is a diagram of a touch sensing apparatus according to an embodiment of the present disclosure.

Referring to FIG. 7, the touch sensing apparatus can include a window 701, a capacitive touch panel 710, and a touch controller 730.

The window 701 can be disposed on the capacity touch panel 710 and have the uneven thickness. For example, the window 701 can be curved based on the x axis 7011 and flat based on the y axis 7012.

The capacity touch panel 710 can include x electrode lines 711 and y electrode lines 712 insulated from the x electrode lines 711. The x electrode lines 711 and the y electrode lines 712 can be alternated in parallel, and include the electrodes.

According to various embodiments of the present disclosure, the electrode size of the x electrode lines 711 and the y electrode lines 712 of the capacity touch panel 710 can be determined by the thickness of the window 701. For example, the gap between the electrodes of the capacity touch panel 710 corresponding to the relatively thick portion of the window 701 can be relatively narrow.

The touch controller 730 can apply the voltage to the x electrode lines 711 and the y electrode lines 712 of the capacitive touch panel 710, and the capacitive touch panel 710 can create the electric field.

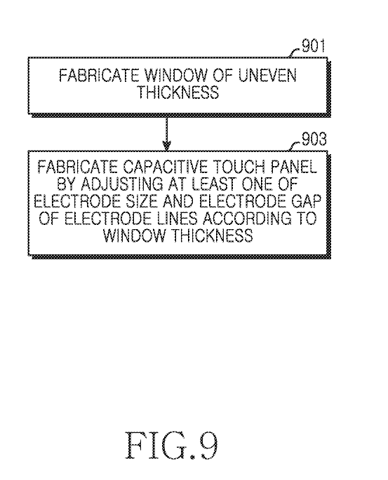

FIG. 9 is a flowchart of a method for manufacturing a touch sensing apparatus according to an embodiment of the present disclosure.

Referring to FIG. 9, at operation 901, the method can fabricate the window of the uneven thickness.

The window is transparent, a bottom side of the window that contacts the capacitive touch panel can be flat, and a top side of the window that is exposed to the external environment can be curved.

At operation 903, the method can fabricate the capacitive touch panel by adjusting at least one of the electrode size and the electrode gap of the electrode lines according to the thickness of the window. The capacitive touch panel can alternate the x electrode lines and the y electrode lines including the electrodes in parallel on the single glass.

The electrode lines can include the relatively wide electrode corresponding to the relatively thick portion of the window.

The electrode lines can include the relatively narrow gap between the electrodes corresponding to the relatively thick portion of the window.

According to various embodiments of the present disclosure, the touch sensing apparatus 302 includes the window 301 of the uneven thickness and the capacitive touch panel 310 disposed under the window 301 and alternating the electrode lines 311 and 312 including the electrodes in parallel. The electrode lines 311 and 312 may be formed such that at least one of the electrode size and the electrode gap is adjusted according to the thickness of the window.

According to various embodiments of the present disclosure, the electrode size corresponding to the relatively thick portion of the window 301 is relatively great.

According to various embodiments of the present disclosure, the gap between the electrodes corresponding to the relatively thick portion of the window 301 is relatively narrow.

According to various embodiments of the present disclosure, the capacitive touch panel 310 forms the electrode lines 311 and 312 on the single glass.

According to various embodiments of the present disclosure, the window 301 includes the flat bottom side contacting the capacitive touch panel 310 and the curved top side exposed to the external environment.

According to various embodiments of the present disclosure, the capacitive touch panel 310 further includes the visible dummy line interposed between the electrodes of the electrode lines 311 and 312.

According to various embodiments of the present disclosure, the touch sensing apparatus 302 further includes the touch controller 330 for applying the voltage to the capacitive touch panel 310 and for detecting the touch based on the change of the electric field generated by the capacitive touch panel 310.

According to various embodiments of the present disclosure, the capacitive touch panel 310 is attached to the window 301 using any one of the SVR, the OCA, or the like.

According to various embodiments of the present disclosure, the touch screen 300 includes the window 301 of the uneven thickness, the capacitive touch panel 310 disposed under the window 301 and alternating the electrode lines 311 and 312 including the electrodes in parallel, the display 320 disposed under the capacitive touch panel 310 and outputting an image from the host device 110, and the touch controller 330 for applying the voltage to the capacitive touch panel 310, detecting the touch based on the change of the electric field generated by the capacitive touch panel 310, and notifying the detected touch to the host device 110. The electrode lines 311 and 312 of the capacitive touch panel 310 may be formed such that at least one of the electrode size and the electrode gap is adjusted according to the thickness of the window 301.

According to various embodiments of the present disclosure, the electrode size corresponding to the relatively thick portion of the window 301 is relatively great.

According to various embodiments of the present disclosure, the gap between the electrodes corresponding to the relatively thick portion of the window 301 is relatively narrow.

According to various embodiments of the present disclosure, the capacitive touch panel 310 forms the electrode lines 311 and 312 on the single glass.

According to various embodiments of the present disclosure, the method for manufacturing the touch sensing apparatus 302 can include fabricating the window 301 of the uneven thickness, and fabricating the capacitive touch panel 310 by adjusting at least one of the electrode size and the electrode gap of the electrode lines 311 and 312 according to the thickness of the window 301.

According to various embodiments of the present disclosure, the method relatively increases the electrode size corresponding to the relatively thick portion of the window 301.

According to various embodiments of the present disclosure, the method relatively narrows the gap between the electrodes corresponding to the relatively thick portion of the window 301.

According to various embodiments of the present disclosure, the method forms the electrode lines 311 and 312 on the single glass.

According to various embodiments of the present disclosure, the window 301 includes the flat bottom side contacting the capacitive touch panel 310 and the curved top side exposed to the external environment.

According to various embodiments of the present disclosure, the method further includes interposing the visible dummy line between the electrodes of the electrode lines 311 and 312.

According to various embodiments of the present disclosure, the method further includes electrically connecting the touch controller 330 which applies the voltage to the capacitive touch panel 310 and detects the touch based on the change of the electric field generated by the capacitive touch panel 310, with the capacitive touch panel 310.

According to various embodiments of the present disclosure, the method further includes attaching the capacitive touch panel 310 to the window 301 using any one of the SVR, the OCA, or the like.

According to various embodiments of the present disclosure, although the window of the uneven thickness is disposed on the capacitive touch panel, the capacitive touch panel creates the uneven electric field per touch region so as to yield the uniform touch sensitivity according to the thickness of the window. Therefore, the uniform touch sensitivity can be provided to the user throughout the touch region regardless of the thickness of the window.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A touch sensing apparatus comprising:
a window having an uneven thickness; and
a capacitive touch panel disposed under the window and having alternating electrode lines comprising a plurality of electrodes in parallel,
wherein at least one of an electrode size and an electrode gap of the electrode lines is formed according to the thickness of the window.

2. The touch sensing apparatus of claim 1, wherein the size of the electrode corresponding to a relatively thick portion of the window is larger than the size of the electrode corresponding to a relatively thinner portion of the window.

3. The touch sensing apparatus of claim 1, wherein the gap of the electrode corresponding to a relatively thick portion of the window is narrow in relation to the gap of the electrode corresponding to a relatively thinner portion of the window.

4. The touch sensing apparatus of claim 1, wherein the capacitive touch panel forms the electrode lines on a single glass.

5. The touch sensing apparatus of claim 1, wherein the window comprises a flat bottom side contacting the capacitive touch panel, and a curved top side exposed to an external environment.

6. The touch sensing apparatus of claim 1, further comprising:
a visible dummy line interposed between the electrodes of the electrode lines.

7. The touch sensing apparatus of claim 1, further comprising:
a touch controller configured to apply a voltage to the capacitive touch panel and to detect a touch based on a change of an electric field generated by the capacitive touch panel.

8. The touch sensing apparatus of claim 1, wherein the capacitive touch panel is attached to the window using any one of Super View Resin (SVR) and Optically Clear Adhesive (OCA).

9. A touch screen comprising:
a window having an uneven thickness;
a capacitive touch panel disposed under the window and having alternating electrode lines comprising a plurality of electrodes in parallel;
a display disposed under the capacitive touch panel and configured to output an image provided from a host device; and
a touch controller configured to apply a voltage to the capacitive touch panel, to detect a touch based on a change of an electric field of the panel, and to notify the host device of a detected touch,
wherein at least one of an electrode size and an electrode gap of the electrode lines of the capacitive touch panel is formed according to the thickness of the window.

10. The touch screen of claim 9, wherein the size of the electrode corresponding to a relatively thick portion of the window is larger than the size of the electrode corresponding to a relatively thin portion of the window.

11. The touch screen of claim 9, wherein the gap of the electrode corresponding to a relatively thick portion of the window is narrow in relation to the gap of the electrode corresponding to a relatively thin portion of the window.

12. The touch screen of claim 9, wherein the capacitive touch panel forms the electrode lines on a single glass.

13. A method for manufacturing a touch sensing apparatus, the method comprising:
fabricating a window having an uneven thickness; and
fabricating a capacitive touch panel by adjusting at least one of an electrode size and an electrode gap of electrode lines according to the thickness of the window.

14. The method of claim 13, wherein the size of the electrode corresponding to a relatively thick portion of the window is relatively increased in relation to the size of the electrode corresponding to a relatively thin portion of the window.

15. The method of claim 13, wherein the gap of the electrode corresponding to the relatively thick portion of the window is relatively narrowed in relation to the gap of the electrode corresponding to the relatively thin portion of the window.

16. The method of claim 13, wherein the electrode lines are formed on a single glass.

17. The method of claim 13, wherein the window forms a flat bottom side contacting the capacitive touch panel, and a curved top side exposed to an external environment.

18. The method of claim 13, further comprising:
interposing a visible dummy line between the electrodes of the electrode lines.

19. The method of claim 13, further comprising:
electrically connecting a touch controller which applies a voltage to the capacitive touch panel and which detects a touch based on a change of an electric field generated by the capacitive touch panel, with the capacitive touch panel.

20. The method of claim 13, further comprising attaching the capacitive touch panel to the window using any one of Super View Resin (SVR) and Optically Clear Adhesive (OCA).
